(19) United States
(12) Patent Application Publication
(10) Pub. No.: US 2020/0130957 A1
(43) Pub. Date: Apr. 30, 2020

(54) SUCTION GRIPPER

(71) Applicant: J. Schmalz GmbH, Glatten (DE)

(72) Inventors: Alexander BOROWSKI, Koenigsfeld (DE); Daniel BIENGER, Fluorn-Winzeln (DE); Fabian SCHNEIDER, Pfalzgrafenweiler (DE); Stefanie MERZ, Lossburg (DE)

(21) Appl. No.: 16/663,690

(22) Filed: Oct. 25, 2019

(30) Foreign Application Priority Data
Oct. 25, 2018 (DE) 10 2018 126 684.7

(51) Int. Cl. B65G 47/91

(52) U.S. Cl. CPC B65G 47/918

(57) ABSTRACT

The invention relates to a suction gripper (10) having a gripper base body (12) with a suction side (14) and a plurality of suction points (16), a vacuum connection (18), and a vacuum distribution system (28) with distribution spaces (30) for connecting the suction points (16) with the at least one vacuum port (18). In this case, the gripper base body (12) is sandwiched and has a bottom plate (20), a cover plate (24) and a profile core (22), wherein the profile core (22) has a plurality of wall sections (32), which extend between cover plate (24) and bottom plate (20) in such a way that a plurality of cavities (34) are formed in the gripper body (12) and wherein the manifold spaces (30) of the vacuum manifold system (28) are formed by at least a subset of the cavities (34).

### FIELD OF INVENTION

The invention relates to a suction gripper for sucking objects by means of vacuum pressure, having a gripper base body with a suction side having a plurality of suction points; at least one vacuum connection for operating the suction gripper by means of vacuum pressure; and a vacuum distribution system with distribution chambers for connecting the suction points with the at least one vacuum connection. Such suction grippers have a planar, mostly flat suction surface with a plurality of suction points. These suction grippers are also referred to as suction grippers or surface suction grippers (large-area vacuum grippers) and are used, for example, for handling large-area objects. In addition, surface suction grippers are used to simultaneously receive a plurality of juxtaposed objects and to provide handling. The objects are then sucked side by side on the extended suction surface and fixed in this manner.

### DESCRIPTION OF RELATED ART

EP 1 052 201 B1 describes a suction gripping head for sucking objects by means of vacuum pressure, having a gripper base body with a suction side having a plurality of suction points; at least one vacuum connection for operating the suction gripper by means of vacuum pressure; and a vacuum distribution system with distribution chambers for connecting the suction points with the at least one vacuum connection. The suction gripping head has a bottom plate with suction openings, a vacuum distribution system and a suction box, which is constructed on the bottom plate and surrounds the vacuum distribution system. WO 2014/114621 A1 shows a surface suction gripper with a housing designed as a hollow profile, wherein an insertion member can be inserted into and pulled out of the housing. The insertion member provides a vacuum distribution system.

The known solutions have a certain structural complexity, which leads to an increased net weight and makes a certain height of the suction gripper necessary. In particular, when used for handling large-area and heavy objects, such as expanded metal parts, such as in bodywork or in the handling of glass panes, or in the handling of flat packages, the housing construction must withstand high tensile forces perpendicular to the suction surface and bending moments. This places high demands on the strength of the housing construction and makes the development of grippers with low net weight and low height difficult.

With the present invention, a surface suction gripper with high mechanical strength, low net weight and low height is to be provided. In addition, complexity in the manufacture of the surface suction gripper is to be reduced.

### SUMMARY OF THE INVENTION

This problem is solved by a suction gripper for sucking objects by means of vacuum pressure, having a gripper base body with a suction side having a plurality of suction points; at least one vacuum connection for operating the suction gripper by means of vacuum pressure; and a vacuum distribution system with distribution chambers for connecting the suction points with the at least one vacuum connection, wherein the gripper base body features a bottom plate providing a suction side, a cover plate and a profiled core, the profiled core is fixed between the bottom plate and cover plate, the profiled core features a plurality of wall sections, which extend between the cover plate and bottom plate such that a plurality of cavities are formed in the gripper base body, and distribution spaces of the vacuum distribution system are formed of at least a subset of the plurality of cavities. This is a surface suction for sucking and fixing objects by means of vacuum pressure (i.e. negative pressure). The suction gripper comprises a gripper base body with a suction side, which has a plurality of suction points. The suction points are preferably positioned regularly on the suction side, for example, arranged in a matrix-like manner or in rows, so that it is also possible to grip extensively extended objects. In addition, at least one vacuum connection for supplying the surface suction gripper with vacuum pressure is provided. In this respect, the surface suction gripper is operated by subjecting the suction points to vacuum pressure and exercising a suction force at the suction points. The surface suction gripper also comprises a vacuum manifold system having a plurality of distribution spaces that fluidly connect the suction points to the at least one vacuum port.

The gripper base body is in particular sandwiched and comprises a bottom plate, which provides the suction side or forms the suction side, a cover plate and a profile core. The profile core is preferably sandwiched between the bottom plate and cover plate and fixed there. The profile core is designed in particular as a coherent structural unit and comprises a multiplicity of wall sections which extend between the cover plate and the bottom plate such that a plurality of cavities are formed in the gripper base body. At least some of the cavities form the so-called distribution spaces of the vacuum distribution system.

In this respect, each of the said distribution spaces is provided by one of the cavities. However, this does not exclude that some of the cavities do not contribute to the vacuum distribution system and, for example, are inoperative for the pneumatic operation of the suction gripper. It is also conceivable, however, that each of the cavities also forms a distribution space of the vacuum distribution system. In particular, the cavities are at least partially bounded by the wall sections themselves, i.e. the wall sections at least partially represent the walls of the cavities. However, the cavities may also be partially bounded by the cover plate and/or bottom plate, so that a cavity is delimited by wall section and cover plate and/or bottom plate.

Cover plate, profile core and bottom plate are in particular sandwiched together. As a result of this design as a sandwich structure with the inner profile core, the gripper base body is given a high mechanical rigidity and strength. In this respect, the profile core or the wall sections of the profile core stabilizes the overall structure. In particular, the profile core (in particular its wall sections) forms an inner support structure of the gripper base body. As a result, a high resistance to tensile forces can be achieved, which act perpendicular to the bottom plate or cover plate. The suction gripper can therefore have a high load capacity.

Through the wall sections between the bottom plate and cover plate, a plurality of space regions are separated from each other, which form the vacuum distribution system. In other words, the cavities formed in the profile core are used as an integrated vacuum distribution system. Therefore, to provide the vacuum distribution system, no additional components are required, so that the suction pad can have a low net weight. When using such suction pads in automated processing systems, lower masses must therefore be moved and energy can be saved.

The, for example, sandwich-like structure of the housing body allows a simplified production of the suction gripper. The sandwich-like gripper base body can be provided, for example, on the bottom plate with openings for the suction point and on the cover plate with distribution accesses for the vacuum access. In particular, it is possible first to produce a large-area sandwich structure and to detach from this several gripper base bodies of the type mentioned. The structure can be produced, for example, as a plastic component, in the manner of a hollow profile reinforced by the internal structure of the profile core. Also conceivable is production as an extruded profile.

In principle, it is possible that a plurality of pneumatically independent vacuum connections are provided. In particular, it is conceivable that each subset of the suction points are supplied by a separate vacuum connection with vacuum pressure. This allows a sectioning of the suction surface in that groups of suction points can each be independently activated and deactivated. In this respect, several independent suction circuits can be provided in the gripper base body.

The suction points can be formed, for example, as suction openings in the suction side. It is also conceivable that an additional coating (e.g. sealing foam) is provided on the suction side. It is also conceivable that the suction points are each occupied with separate suction heads (e.g. elastomer suction pads, suction cups, bellows suction cups) or other suction gripper apparatuses.

The vacuum pressure port designates the transition from a vacuum pressure supply to the vacuum pressure distribution system of the surface suction gripper. However, this does not mean that the surface suction gripper in its entirety must necessarily be connected to a vacuum line. Rather, the surface suction gripper can be connected in total to a compressed air system and additionally include a compressed-air-operated vacuum generator (e.g. ejectors). For further refinement, one or more ejectors can be positioned and fixed on the cover plate, wherein the ejectors supply the vacuum connection with vacuum pressure. This integrated design makes it possible to design the suction gripper to be compact.

Preferably, the wall sections form a spatially regular, in particular a periodically repeating structure between bottom plate and cover plate. The structure is preferably regular or periodic, considered in a plane, which extends parallel to the cover plate and/or bottom plate. Preferably, the regular or periodic structure completely fills the space between the bottom plate and the cover plate. For example, the profile core is designed for this purpose as a honeycomb plate or corrugated plate. Thereby, a spatially regular support structure can be provided and a high strength and rigidity of the gripper base housing can be achieved.

Preferably, the wall sections are monolithically connected to each other, so that the profile core is a coherent component and the wall sections are part of a contiguous wall structure. The sandwich structure thus essentially comprises three functional units, namely bottom plate, profile core and cover plate, which each represent connected components. However, this does not exclude that the housing base body is formed as a whole and integral component.

For further refinement, the profile core also has intermediate walls which extend parallel to the cover plate and/or the bottom plate. In particular, the intermediate walls are connected to the so-called wall sections, in particular integrally connected. The intermediate walls may, for example, extend between adjacent wall sections. The intermediate walls can, for example, complete the profile core in the direction of the cover plate and/or in the direction of the bottom plate. This allows a stable fixation of the various components together and leads to a high resistance to tensile forces perpendicular to the surface of the bottom plate and/or cover plate. However, it may also be advantageous if intermediate walls in the profile core extend in such a way that they are spaced from both the cover plate and the bottom plate. Preferably, the intermediate wall extends centrally between the bottom plate and cover plate. As a result, cavities are provided which do not extend over the entire overall height of the gripper base part and thus have a reduced volume. Such cavities may be advantageous for providing a vacuum distribution system having certain pneumatic properties (e.g., short evacuation times).

In principle, it is advantageous if the cover plate and bottom plate extend parallel to one another. Cover plate and/or bottom plate are preferably formed to be flat. Thereby, the gripper body can be formed in its entirety in the manner of an even, flat plate. It is also conceivable that cover and bottom plate comprise a wavy or profiled course (uneven) and the gripper body has a corrugated or profiled course overall.

When viewed along a surface normal of the cover plate and the bottom plate, the cover plate and/or the bottom plate in each case preferably cover identical surface areas and thus have an equally large cross-sectional area. Cover plate and bottom plate are preferably arranged one above the other in alignment. In particular, the profile core also extends over the entire surface area, which is covered by the cover plate and bottom plate. As a result, all the layers of the sandwich structure have substantially the same areal extent and a stable sandwich-type composite part can be produced.

An advantageous embodiment is that the profile core is formed plate-like in its entirety and has a plurality of different areas, which lie on at least two different height levels (with respect to an imaginary reference plane of the plate-like extent of the profile core). In this case, the wall sections, which separate the different cavities from each other, preferably extend between the areas of different levels. In this respect, the profile core is formed as a wave plate or buckling plate, for example, like a corrugated sheet. This makes it possible to produce the profile core as a contiguous component.

At least some of the wall sections, or all wall sections, may have a bend and/or a wave along their extension between bottom plate and cover plate. This embodiment can increase the mechanical stability of the overall construction. In addition, the profile core can be manufactured as an intrinsically stable component and processed.

However, a simple configuration which is stable against tensile forces can also result from the fact that at least some or all of the wall sections are straight and, in particular, flat.

Preferably, at least some or all wall sections of the profile core run obliquely to the cover plate and/or to the bottom plate. Thereby, the mechanical stability can be increased and cavities with certain advantageous geometries can be generated.

However, a simple construction of the gripper base body also results from the wall sections (at least some or all wall sections) being perpendicular to the cover plate and/or the bottom plate.

In an advantageous embodiment, at least some of the wall sections extend in pairs inclined relative to each other. This results in a particularly high stability of the profile core against shear forces. Preferably, some of the wall sections are inclined with respect to a surface normal of the cover plate and/or the bottom plate opposite to each other. In this respect, some wall sections may each extend in pairs toward and/or away from one another (e.g. along the path from the bottom plate to the cover plate). Overall, it may be advantageous if the wall sections considered in a sectional plane perpendicular to the cover plate and/or bottom plate form a truss structure.

In plan view, so when viewed along the surface normal of the cover plate and/or bottom plate, the wall sections form a honeycomb structure according to an advantageous embodiment. The honeycomb structure has honeycombs which form the cavities. In this respect, the wall sections run in such a way that, viewed along the surface normal, closed honeycombs are formed. Such a honeycomb can then each be assigned a suction point or in each case several suction points.

It is conceivable that the wall sections extend in such a way that the cross-sectional area of the honeycomb changes along the extent of the honeycomb between the bottom plate and the cover plate. It is also conceivable that the cross-sectional area initially decreases along the extent of the honeycomb from the bottom plate to the cover plate and then increases again. The reverse embodiment may also be advantageous, wherein the cross-sectional area of the honeycomb initially increases and then decreases again. The honeycombs preferably have a polygonal cross section, so that the surface covered by the profile core can be filled completely with honeycombs. This can be realized for example by a pyramidal shape of the honeycomb. For certain embodiments, round cross-sectional areas may also be advantageous.

It may also be advantageous if the honeycombs comprise a constant cross-sectional area along the extent of the honeycomb from the bottom plate to the cover plate. The cavities thus formed are then preferably all identical to one another.

An advantageous embodiment also results from the fact that the wall sections run such that at least some of the cavities are formed as elongated channels, which extend parallel to the bottom plate and/or to the cover plate. Preferably, the channels extend over the entire surface area, which is covered by the profile core, i.e. in particular over the entire extent of the suction side. In each case a plurality of suction points can be arranged in channels, such that the suction points can be supplied with vacuum pressure by the respective associated channel. For further configuration, the channels are parallel to each other. It is also conceivable that the channels form a kind of grid on the suction side.

According to a fundamental aspect, the wall sections preferably extend in such a way that at least some of the cavities are sealed in pairs against each other. The mutually sealed cavities are especially those which provide the distribution spaces.

The structure of the gripper body allows an advantageous aggregation of the suction points on the suction side into functionally independent groups. In this case, for example, each distribution space can be assigned a plurality of suction points which are flow-connected to the vacuum connection via the respective distribution space. As a result, suction points, which are each assigned to different distribution chambers, are subjected to vacuum pressure independently of one another. In this respect, several independent suction circuits can be formed. This sectioning makes it possible, for example, to suck a plurality of objects arranged next to one another simultaneously next to one another on the extended suction surface and, if appropriate, to let them go independently of one another.

In particular, it can be provided that a plurality of separate vacuum connections are provided and at least two distribution chambers are assigned to two different vacuum connections (i.e., the vacuum supply of the two distribution chambers is effected by means of different vacuum connections). This makes it possible to apply vacuum pressure to the respective associated suction points of different distribution spaces independently. As a result, the suction points can be combined into groups of suction points so that the suction point groups can be operated independently of each other. This makes it possible to deactivate unneeded suction points, for example, when objects are to be gripped which do not completely cover the suction side.

However, an advantageous embodiment may also consist in each distribution space being assigned only one suction point or only a small number of suction points (e.g. two to eight suction points). If different vacuum connections are then available for each distribution space, the individual suction points can be controlled independently of each other.

For further refinement, the cover plate has a distribution access for each distribution space or for each group of distribution spaces. The distribution access can open as a breakthrough or bore through the cover plate into the respective distribution space. In particular, the distribution access is aligned with the respective distribution space with respect to the surface normal of the cover plate. Thus, the connections for the individual distribution spaces can be made in a simple manner from above through the cover plate. As a result, for example, a control valve can be provided in a simple manner for each distribution space, which control valve is likewise arranged on the cover plate, in particular above the respective distribution space.

The wall sections preferably run in such a way that the profile core is mirror-symmetrical with respect to a median plane between the bottom plate and the cover plate. It is also conceivable that the profile core is formed symmetrically with respect to a rotation through 180° about an axis extending in the median plane, i.e. that the profile core appears the same as this axis after rotation by 180°. It is also conceivable that the structure of the profile core is axisymmetric with respect to an axis of symmetry which extends in the profile core between the bottom plate and cover plate, in particular runs parallel to the bottom plate and cover plate. This embodiment allows for easy production as a sandwich profile and a simplified further processing of the gripper base body, since only openings for suction points and distribution access must be created, and the top and bottom of the gripper body can be determined later.

According to an advantageous aspect of the invention, the gripper body is monolithic. In this respect, in particular cover plate, profile core and bottom plate are integrally connected to each other, for example, materially connected to each other.

Cover plate, profile core and bottom plate can be produced in particular from the same material. Conceivable for this are, for example, plastic, fiber composites, carbon, aluminum, cardboard, etc.

However, it may also be advantageous if the gripper base body is formed as a composite component, wherein at least one of the bottom plate, cover plate and profile core components is made of a material which differs from the material of the other components. As a result, the suction pad can be designed as required in terms of weight and strength.

For further refinement, some of the cavities may be filled with a filling material which differs from the material of the wall sections. The filling material is in particular made to be porous, for example formed as a foam. Preferably, filling material is provided in precisely those cavities which do not act as distribution spaces. As a result, the mechanical stability can be increased without this being associated with a significant weight increase.

The invention will be explained in more detail in the following with reference to the drawings.

### BRIEF DESCRIPTION OF THE DRAWINGS

In the drawings:

FIG. 1: is an overall view of a surface suction gripper;

FIG. 2: is a detail of a longitudinal section with sectional plane A-A in FIG. 1;

FIG. 3: is a representation of a section through the gripper base body of a first design possibility;

FIG. 4: is a sectional view through the gripper base body in a further design possibility;

FIGS. 5 to 7: are sectional views through gripper base body to illustrate further design possibilities;

FIGS. 8 to 10: are plan views of profile cores in sketched illustration to explain further design possibilities;

FIG. 11: is a sketch of a section through a gripper base body for explaining a configuration with filling material; and

FIG. 12: is a sketched representation of a section through a gripper base body according to a further design possibility.

In the following description and in the drawings, the same reference signs are used in each case for identical or corresponding features.

### DETAILED DESCRIPTION OF THE BEST MODE OF THE INVENTION

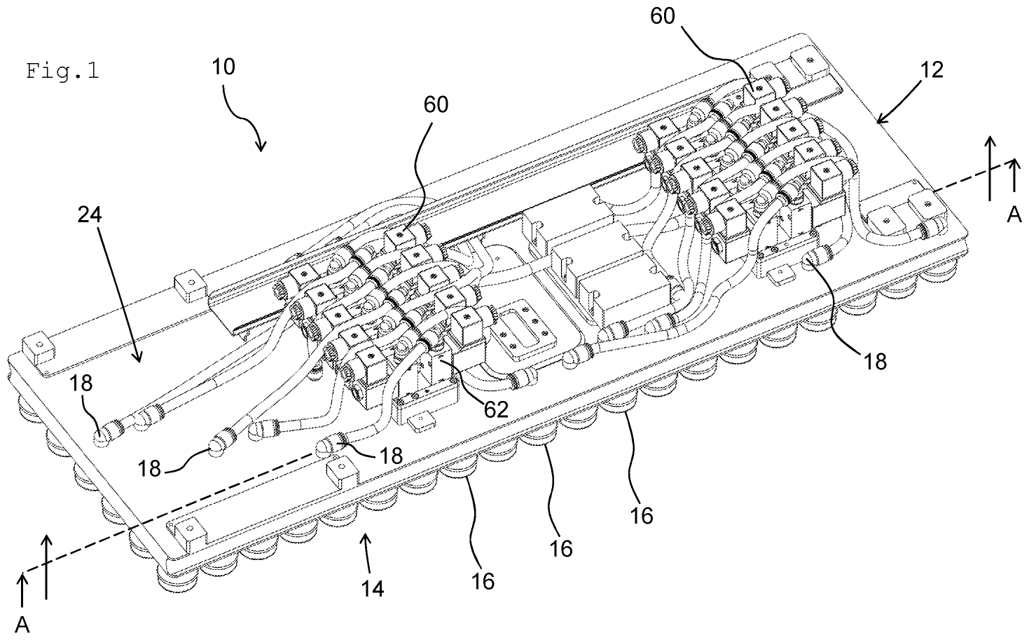

FIG. 1 shows a suction gripper designated in its entirety by the reference numeral 10 suction gripper (surface suction gripper) in a perspective view. The suction gripper 10 has an overall plate-like gripper base body 12, the underside of which forms a suction side 14, on which a plurality of suction cups 16 are provided arranged in the manner of a matrix. The suction points 16 are formed in the illustrated example as an elastomer suction cup, in particular a bellows suction cup. The gripper body also has a plurality of vacuum connections 18.

FIG. 2 shows a detailed view of a longitudinal section through the gripper base body 12 along the line A-A in FIG. 1 with a sectional plane extending perpendicular to the suction side 14. The gripper base body 12 accordingly has a sandwich-type structure and comprises a bottom plate 20, a profile core 22 abutting the bottom plates 20 and a cover plate 24 abutting the profile core. The suction points 16 are provided on the bottom plate 20, so that the bottom plate 20 in total provides the suction side 14 of the next suction pad 10. The vacuum ports 18 are provided on the cover plate 24. Each suction point 16 is assigned a bellows suction cup 26 in the example shown.

The suction gripper 10 has a system, referred to in its entirety as a vacuum distribution system 28, made of distribution spaces 30 in the interior of the gripper base body 12. The distribution spaces 30 are formed by the profile core 22 having a plurality of wall sections 32 which extend between the bottom plate 20 and the cover plate 24. As a result, a plurality of cavities 34 are separated in the gripper base body 20. In the illustrated example, some of the cavities 34 each act as distribution spaces 30 of the vacuum distribution system 28.

As can be seen in FIG. 2, a cavity 34 acting as a distribution space 30 is connected from the side of the cover plate 24 to a distribution access 36, which in turn is flow-connected to a corresponding vacuum connection 18.

In principle, a plurality of suction points 16 can open into a distribution space 30, so that they can be subjected to vacuum pressure via the distribution space 30, the associated distribution access 36 and the corresponding vacuum connection 18.

In this respect, the wall sections 32 of the profile core 22 together with the bottom plate 20 and cover plate 24 form a plurality of cavities 34, wherein some of the cavities 34 act as distribution spaces 30. Here, various configurations for the profile core 22 may be advantageous.

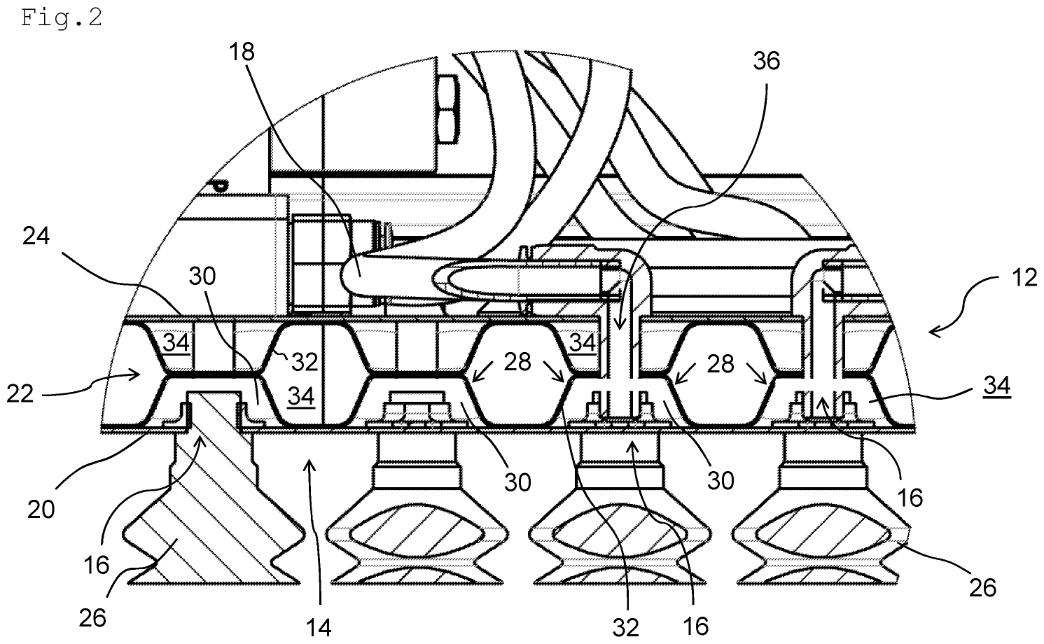

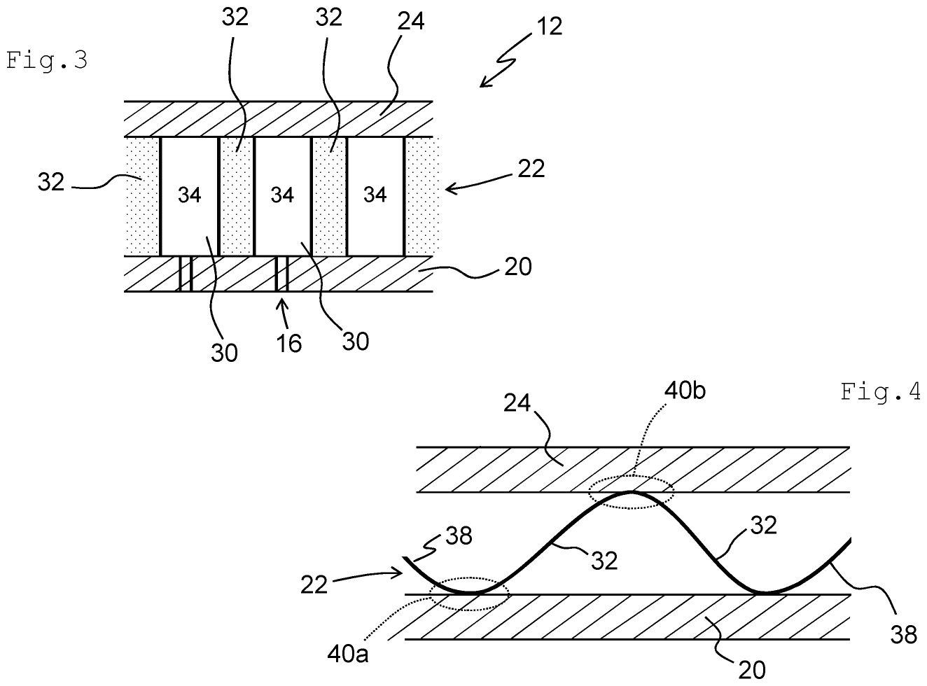

In FIGS. 3 to 6, excerpts from a gripper base body 12 are shown in a sketched representation, for example in a sectional view corresponding to FIG. 2.

Preferably, the wall sections form a spatially regular and periodically repeating structure, in particular when viewed in a longitudinal section perpendicular to the bottom plate 20 or cover plate 24 (see FIGS. 3 to 6).

The wall sections 32 may, for example, run flat and extend substantially perpendicularly between the bottom plate 20 and the cover plate 24 (cf., FIG. 3). As a result, a number of cavities 34 are formed which, depending on the course of the wall sections 32, can be configured cylindrically with a polygonal base surface.

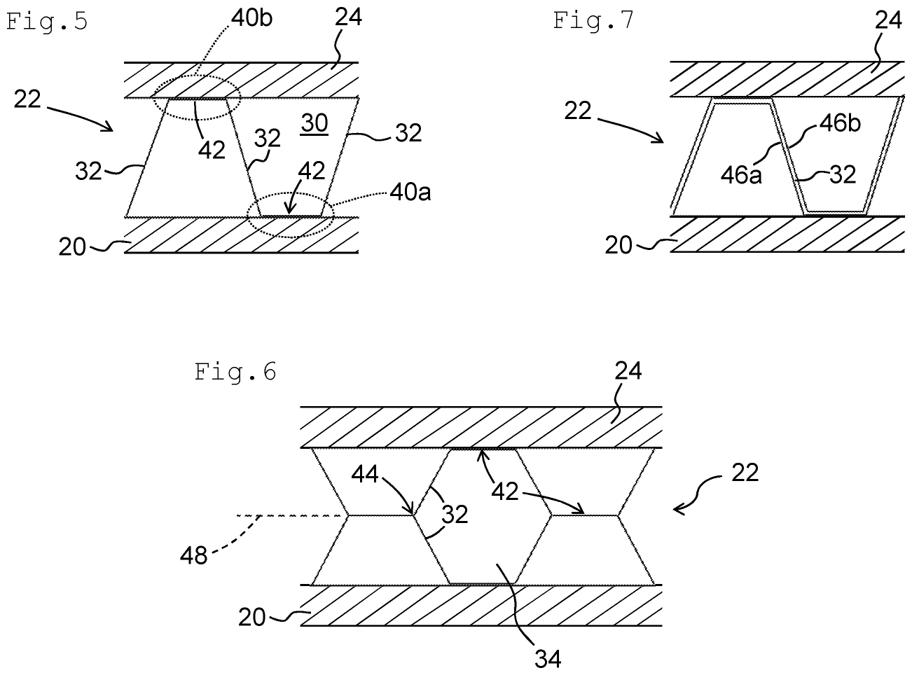

The profile core 22 may also comprise a substantially continuous and connected wall 38, and, for example, run in a wavy manner between the cover plate 24 and bottom plate 20 (see FIG. 4). This is an exemplary realization that the profile core is formed as a whole plate-like and has a wall structure which has a plurality of areas at different height levels 40a, 40b (see FIG. 4). For this purpose, the wave structure is not mandatory (cf., for example, FIG. 5 with wall sections 32, which has a wave-free profile).

The wall sections 32 may run obliquely to the cover plate 24 and/or bottom plate 20 (cf., FIGS. 5 to 7). The profile core 22 may, in addition to the wall portions 32 which extend between the bottom plate 20 and cover plate 24, also comprise intermediate walls 42 which extend substantially parallel to the bottom plate 20 and/or cover plate 24 (see, e.g., FIGS. 5 and 6). However, the intermediate walls 42 can also run obliquely. In principle, the wall section 32 can also extend between the bottom plate 20 and the cover plate 24 in such a way that a kink 44 or a wave is formed (see FIG. 6). This makes it possible to realize various geometries for the cavities 34 and thus the distribution spaces 30.

The profile core 22 can be realized, for example, by joining together two or more complementary fitting plates 46a, 46b (see FIG. 7). As a result, a high mechanical strength can be achieved. In this respect, the wall sections 32 are then designed as double walls or multiple walls.

In principle, the profile core 22 may be mirror-symmetrical with respect to a median plane 48 between the bottom plate 20 and the cover plate 24 (see, for example, FIG. 6).

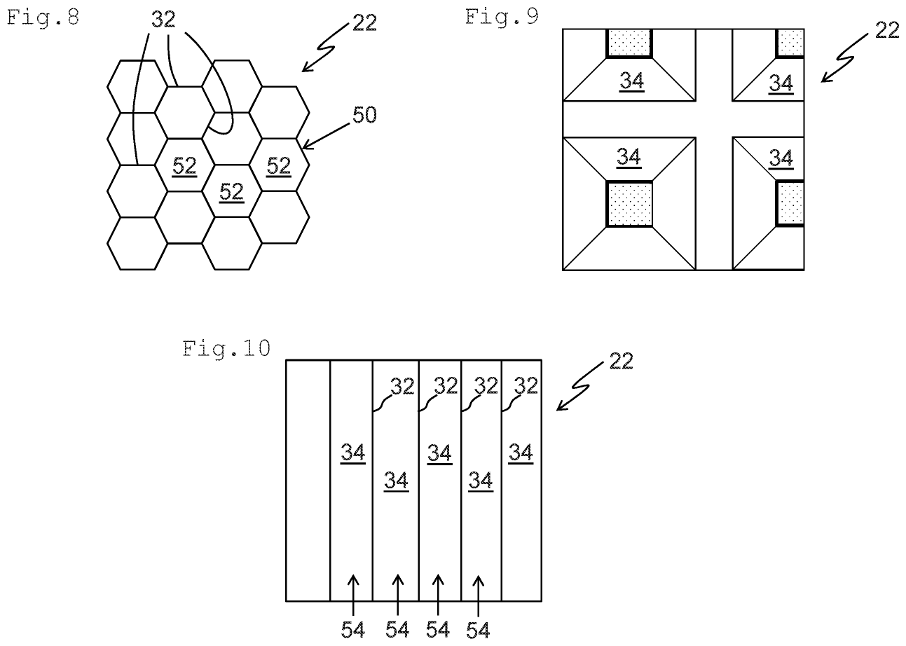

In the FIGS. 8 to 10, sketched representations of a plan view of the profile core 22 and on the structure formed by the wall sections 32 are shown. The plan view is a view along a surface normal on the bottom plate and/or cover plate 24.

The wall sections 32 may extend in such a way that a honeycomb structure 50 is formed with a plurality of honeycombs 52 (see FIG. 8). The suction points 16 may be positioned on the bottom plate 20 such that a honeycomb 52 is associated with one or several suction points. The honeycomb structure 50 preferably comprises polygonal honeycombs 52 (see FIG. 8).

FIG. 9 shows a profiled core 22 in plan view, which has pyramidal cavities 34. Such a profile core 22 can be achieved, for example, by the embodiment according to FIG. 5, when the walls 32 of the profile core 22 are designed in the manner of capped pyramids with a square base surface. Insofar, the profile core 22 according to FIG. 9 has honeycombs with a square base surface, wherein the cross section of each honeycomb changes along the course from the bottom plate 20 to the cover plate 24.

However, the wall sections 32 of the profile core 22 can also be designed so that the cavities 34 are formed as channels 54 which extend in the profile core 22 parallel to the bottom plate 20 and/or cover plate 24 (see FIG. 10). Such a profile core can be realized, for example, with the embodiment according to FIG. 5, when the wall sections 32 extend along the suction side 14 and are not closed to pyramidal structures.

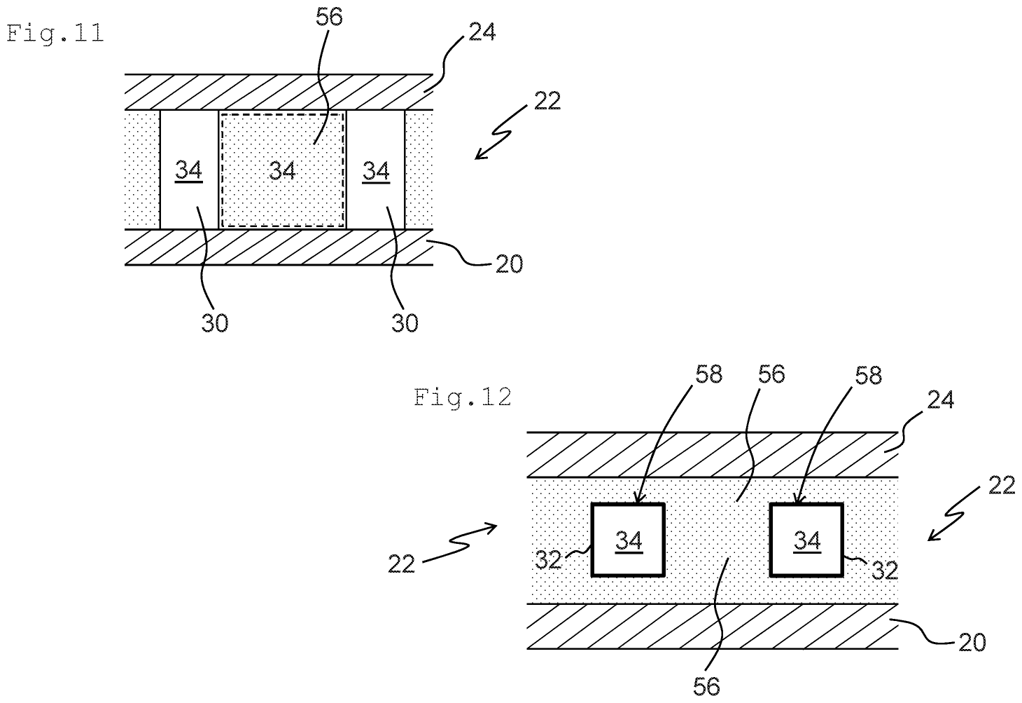

Some of the cavities 34 may be filled with a preferably porous filling material 56 (see FIG. 11). Preferably, those cavities 34 are filled with the filling material 56, which does not act as distribution spaces 30.

Filling certain regions of the profile core 22 with filling material 56 also makes it possible to produce cavities 34 in the profile core 22 which are not connected by wall sections to the bottom plate 20 and/or cover plate 24 (see FIG. 12). For this purpose, for example, a tubular insert 58 may be accommodated in the filling material 56. The interior of the insert 58 then forms one of said cavities 34. The walls of the tubular insert 56 form wall sections 32 (see FIG. 12).

The sandwich-like configuration of the gripper base body 12 makes it possible to arrange on the cover plate 24, in addition to the vacuum connections 18, further functional units of the suction gripper 10. For example, compressed-air-operated vacuum generators 60 and/or valve devices 62 can be mounted on the cover plate 24, the overall structure being compact and clear (see FIG. 1).

1. Suction gripper (10) for sucking objects by means of vacuum pressure, comprising:
a gripper base body (12) with a suction side (14) having a plurality of suction points (16);
at least one vacuum connection (18) for operating the suction gripper (10) by means of vacuum pressure;
a vacuum distribution system (28) with distribution chambers (30) for connecting suction points (16) with the at least one vacuum connection (18),
characterized in that the gripper base body (12) comprises a bottom plate (20) providing a suction side (14), a cover plate (24) and a profiled core (22), wherein the profiled core (22) is fixed between the bottom plate (20) and cover plate (24),
wherein the profiled core (22) comprises a plurality of wall sections (32), which extend between the cover plate (24) and bottom plate (20) such that a plurality of cavities (34) are formed in the gripper base body (12), and
wherein distribution spaces (30) of the vacuum distribution system (28) are formed of at least a subset of the plurality of cavities (34).

2. Suction gripper (10) according to claim 1, wherein the wall sections (32) form a spatially regular, in particular periodically repeating, structure between the bottom plate (20) and cover plate (24).

3. Suction gripper (10) according to claim 1, wherein the plurality of wall portions (32) are integrally connected to each other.

4. Suction gripper (10) according to claim 1, wherein the profile core (22) comprises intermediate walls (42) which run parallel to the cover plate (24) and/or bottom plate (20).

5. Suction gripper (10) according to claim 1, wherein, when viewed from above along a surface normal, the cover plate (24) and the bottom plate (20) cover identical areas to the cover plate and/or bottom plate, respectively, and the profile core (22) extends over the entire covered surface area.

6. Suction gripper (10) according to claim 1, wherein the profiled core (22) is formed plate-like and has a plurality of areas on at least two different height levels (40a, 40b), wherein the plurality of wall portions (32) extend between the areas of different height levels (40a, 40b).

7. Suction gripper (10) according to claim 1, wherein the plurality of wall portion (32) has a kink (44) or a wave along an extension between the bottom plate (20) and cover plate (24).

8. Suction gripper (10) according to claim 1, wherein at least some wall sections (32) extend obliquely to the cover plate (24) and/or bottom plate (20).

9. Suction gripper (10) according to claim 1, wherein at least some of the wall sections (32) are inclined relative to each other.

10. Suction gripper (10) according to claim 1, wherein the plurality of wall sections (32), when viewed along the surface normal on cover plate (24) and/or bottom plate (20), form a honeycomb structure (50).

11. Suction gripper (10) of claim 10, wherein the honeycomb structure (50) comprises a plurality of honeycombs (52), wherein the cross-sectional area increases or decreases along the extent of the honeycomb (52) from the bottom plate (20) to the cover plate (24).

12. Suction gripper (10) according to claim 1, wherein the wall sections (32) extend such that at least some of the cavities (34) are formed as channels (54) which extend parallel to the bottom plate (20) and/or cover plate (24).

13. Suction gripper (10) according to claim 1, wherein the wall sections (32) extend such that at least some of the cavities (34) are sealed in pairs against each other.

14. Suction gripper (10) according to claim 1, wherein each distribution space (30) is assigned a plurality of suction points (16) and these are connected via this distribution space (30) to the vacuum connection (18).

15. Suction gripper (10) according to claim 1, wherein the cover plate (24) comprises at least one distribution access (36) which opens into a distribution space (30) or into a group of distribution spaces (30).

16. Suction gripper (10) according to claim 1, wherein the profile core (22) is mirror-symmetrical with respect to a median plane (48) between the bottom plate (20) and cover plate (24).

17. Suction gripper (10) according to claim 1, wherein the gripper base body (12) is integrally formed, wherein preferably cover plate (24), profile core (22) and bottom plate (20) are made of the same material.

18. Suction gripper (10) according to claim 1, wherein the subset of the cavities (34) are filled with a filling material different from that of the plurality of wall sections (32), including a porous filling material (56) like foam.

19. Suction gripper (10) according to claim 2, wherein the plurality of wall portions (32) are integrally connected to each other.

20. Suction gripper (10) according to claim 2, wherein the profile core (22) comprises intermediate walls (42) which run parallel to the cover plate (24) and/or bottom plate (20).
